(19) United States
(12) Patent Application Publication
(10) Pub. No.: US 2004/0238662 A1
(43) Pub. Date: Dec. 2, 2004

(54) De-coking tool

(76) Inventor: Wolfgang Paul, Bad Schwartau (DE)

Correspondence Address: George A Coury, Bachman & LaPointe, 900 Chapel Street, Suite 1201, New Haven, CT, 06510-2802, US

(21) Appl. No.: 10/484,571

(22) PCT Filed: Jul. 23, 2002
(86) PCT No.: PCT/EP02/08191

(30) Foreign Application Priority Data
Jul. 23, 2001 (DE) 101 34 951.3
Jul. 30, 2001 (DE) 101 36 597.7

(51) Int. Cl. B02C 19/18

(52) U.S. Cl. 241/1

(57) ABSTRACT

The invention relates to a tool for disintegrating coke, having a housing attached to a drill stem in operation, and at which or in which at least one nozzle for cutting and a nozzle for drilling of coke and at least one valve for closing and opening the nozzles is arranged, wherein said tool is adapted to have two different operating states and wherein said at least one valve closes off said cutting nozzles in the drilling operating state, while the drilling nozzles are closed off by said at least one valve in the cutting operating state, and wherein said housing, said valve and said nozzles are adapted so that water may flow unhindered from said drill stem through said housing and said valve and through the nozzles not closed off by said valve, characterized in that the nozzles to be closed, depending on each chosen operating state, are closed off by the balls of a ball valve. The invention further relates to a tool, wherein the arrangement for operating the valve is arranged above the nozzles.

### BACKGROUND OF THE INVENTION

The present invention relates to a tool for disintegrating coke.

In oil refineries, the last, otherwise unusable fraction of the crude oil is transformed into coke. This transformation is performed by feeding this fraction into drums which are filled with coke as the operation proceeds. Once the maximum filling level of the drums has been reached, the coke is cut out from the drums.

This so-called “de-coking” is usually carried out using high-pressure water jets which disintegrate the coke and wash it out of the drums. The tool for generating these high-pressure water jets is inserted into the drums from the top using a drilling rig. The de-coking is carried out in two stages. First, an opening in the drum is cut from the top to the bottom, then the tool is raised back to the top of the drum, and the coke is then disintegrated by the high-pressure water jets generated by cutting nozzles at about right angles to the axis of the bore.

The tool is adapted to assume two operating states, one for drilling an opening needed for moving the tool and then letting the disintegrated coke exit, and one for cutting the coke across the cross-section of the drum. The drilling nozzles accordingly send high-pressure water jets essentially parallel, or at an oblique angle, to an axis formed by the drill stem and the opening arising from the drilling. The cutting nozzles, on the other hand, generate high-pressure water jets aligned essentially at right or obtuse angles to the axis formed by the drill stem and the opening in the drum.

The switch-over between the operating states of drilling and cutting has to be quick and simple. The nozzles used in the tool are subject to wear and tear due to the high water pressure and thus have to be replaced frequently. Therefore, the tool must be adapted in such a way that the replacement of the nozzles can be carried out in a quick and safe manner.

### SUMMARY OF THE INVENTION

The object of the present invention is to provide a tool for disintegrating coke which is particularly simple and safe to use and maintain.

The above object is achieved by a tool having the characterizing features of claim 1. Tools for disintegrating coke with a housing, which is attached to a drill stem in operation and having at least one nozzle for cutting and drilling coke and at least one valve for closing and opening the nozzles arranged on it, are known from the state of the art. These tools are adapted to have two different operating states. The at least one valve closes off the cutting nozzles in the “drilling” operating state, while in the “cutting” operating state, the drilling nozzles are closed off by the at least one valve. The housing, the valve and the nozzles in these tools are formed in such a way that unhindered passage of water from the drill stem through the housing and the valve and through the nozzles not closed off by the valve is ensured.

The design of such a tool is greatly simplified when the nozzles to be closed off, depending on each chosen operating state, are closed off by a ball valve. Combinations comprising a ball valve for opening and closing drilling nozzles and other means for opening and closing cutting nozzles are well known, but they need a multitude of parts and result in a tool with a complex structure.

The present invention is advantageous in that the number of parts is reduced and that it is completely ensured that there is only ever one nozzle or group of nozzles that is closed off and the other nozzle or group of nozzles is open.

The tool comprises a valve which has a valve carrier in engagement with the balls for closing off the nozzles. The valve further includes associated means for guiding the ball and positioning aids, as necessary, by means of which the balls are held in predetermined positions. An apparatus for operating the valve is also associated with the valve. The valve is arranged in the housing of the tool and when operated is flown through or around by the water used to remove the coke.

The balls of the ball valve are guided in the valve carrier by suitable means for guiding balls. One possibility would be to provide means for guiding at the valve carrier. These could be, for example, concave shells or guiding grooves or guiding protrusions in engagement with the balls. Alternatively, an arrangement is possible where the balls associated with the valve carrier are positioned by springs in the positions suitable for each operating state. The means for guiding could therefore either be formed integral with the valve carrier or formed independent of it. The latter embodiment then cooperates with the ball and the valve carrier for guiding the ball. The means for guiding may also be comprised of a plurality of parts, for example a recess or groove in the valve carrier cooperating with a spring arrangement in order to guide the balls.

The balls may be completely spherical. It is, of course, entirely possible for the balls to be spherical only in segments where in an operating state they close off the entry to a nozzle. The spherical form of this surface area ensures that the entry to each nozzle to be closed off is securely sealed against the passage of liquid. A circular disk, one side of which is spherically domed would, for example, be quite sufficient for the purpose of closing the nozzle. This is why bodies that are not entirely spherical in shape will also be referred to as “balls” in the sense of the invention.

Preferably, the balls are symmetrical bodies having at least two spherical surface sections. Usually, these spherical surface sections are opposite to each other, e.g. as calottes, whose maximum circumferences are adjacent to each other. These symmetrical balls have the advantage that on the one hand, because of the symmetry, they are easily guided by the means for guiding. On the other hand, they are advantageous in that, should the first spherical surface section show signs of being worn out, the symmetrical ball could simply be flipped over. Thus, a different calotte with a second spherical surface section could be used for sealing off the nozzle. The symmetrical ball is usually preferred over the completely spherical ball since, if tools are to be designed with a reduced diameter, the symmetrical balls have a smaller thickness, with reference to the diameter of the tool, than completely spherical balls.

According to a first embodiment, the valve carrier is integrated in the housing in such a way that it is a part of the exterior wall of the tool. According to a second embodiment, the valve carrier is mounted within the housing. The means for guiding the ball and the valve carrier, if necessary, are arranged in the housing of the tool, although they usually do not quite fill it. There are thus gaps between the means for guiding the balls and the valve carrier and the housing. According to an advantageous further development of the invention, these gaps are in communication with the interior cavity of the tool so that in operation the liquid flowing through the tool can also flow through these gaps. The advantage of this arrangement is that there are no pressure differentials within the tool between the interior cavity and the gaps between the housing and the valve carrier. Material savings may thus be realized when designing the valve carrier because no pressure differentials, with their associated pressure and pulling forces, must be absorbed. Additionally, the avoidance of pressure differential ensures smooth operation of the ball valves.

A particularly preferred embodiment of the tool according to the present invention, comprises a valve carrier, in which the nozzles for cutting are arranged in two or more levels one on top of the other. This greatly enhances the power of the tool. Preferably, the nozzles are offset from each other in the several levels.

The switch-over from the “drilling” operating state to the “cutting” operating state is carried out manually in most of the prior art tools. The tool is retracted from the drum after the first processing step and a device within the tool is operated, which after completion of the drilling closes off the drilling nozzles directed to the bottom and opens the cutting nozzles.

This device for closing individual, or a plurality of nozzles is operated by means which on the one hand engage the apparatus for closing and on the other hand involve an operating member operable from the outside of the tool. This operating member is always positioned below the tool with prior art de-cooking tools. Arrangements for switching over a de-coking tool according to this design may be robust and well proven. However, they have a particularly serious drawback in that the tool must be completely retracted from the drum, and that for switching over from “drilling” to “cutting”, the cutting nozzles must be at the body height of the operating personnel. In some cases, this can result in heightened risks for the operating personnel, such as when, as has been known to happen, the controlling mechanism fails.

The first approach to avoid this drawback has been to develop automatic arrangements for switching over de-coking tools. This has been problematic, however, since it is difficult to attach the relatively sensitive control mechanisms to the tool which is used in a very harsh environment subject to extreme mechanical and thermal stresses and strains.

The arrangement of the means for operating the apparatus within the de-coking tool for closing off individual, or a plurality of, nozzles, so that the operating member is arranged between the nozzles and the top end of the tool, already ensures that accidents with a manually operable arrangement for switching over may be avoided. This arrangement is considered independent, novel and inventive and suggests a simple and safe tool for disintegrating coke.

With the preferred arrangement, the tool can remain within the drum to be emptied, when the operating state is to be changed from the first to the second, or vice-versa, to such an extent that the cutting nozzles from which high-pressure water jets exit remain covered by the drum. Even for the case where the control devices of the de-coking plant fail, or if it is (erroneously) signalled that the tool can be switched over although high pressure remains applied to it, the operating personnel may approach the tool without the risk of getting hurt by high-pressure water jets.

The apparatus for closing individual, or a plurality of, nozzles have different forms. Some tools are provided with ball valves, other tools have hollow cylinders provided with cut-outs for opening the nozzles. Depending on the position of the cylinder, also connected to a bottom plate provided with cut-outs, as necessary, a high-pressure water jet exits, or the respective nozzle is closed off by the hollow cylinder or the bottom plate. Herein the hollow cylinder covers the cutting nozzles or exposes them, while the bottom plate exposes or closes the drilling nozzles, respectively.

For virtually all of the prior art apparatuses it is possible to provide an arrangement for switching-over the de-coking tool wherein the operating member is upstream of the nozzles and therefore at the top end of the de-coking tool.

It is considered particularly advantageous that existing and, as far as the apparatus for closing off individual, or a plurality of, nozzles is concerned, well proven facilities may be equipped with the arrangement according to the invention.

### BRIEF DESCRIPTION OF THE DRAWINGS

A preferred embodiment of the present invention will now be described in detail in the following with reference to the accompanying drawings, wherein:

FIG. 1 shows a longitudinal sectional view of an embodiment of the tool of the present invention in the “drilling” operating state;

FIG. 2 shows a second longitudinal sectional view of an identical embodiment of the tool according to the present invention in the “drilling” operating state, at an angle to the sectional view of FIG. 1;

FIG. 3 shows a longitudinal sectional view of an embodiment of the tool of the present invention in the “cutting” operating state;

FIG. 4 shows a second longitudinal sectional view of an identical embodiment of the tool according to the invention in the “cutting” operating state, at an angle to the sectional view of FIG. 3; and

FIG. 5 shows a sectional view of a tool according to a second embodiment.

### DETAILED DESCRIPTION

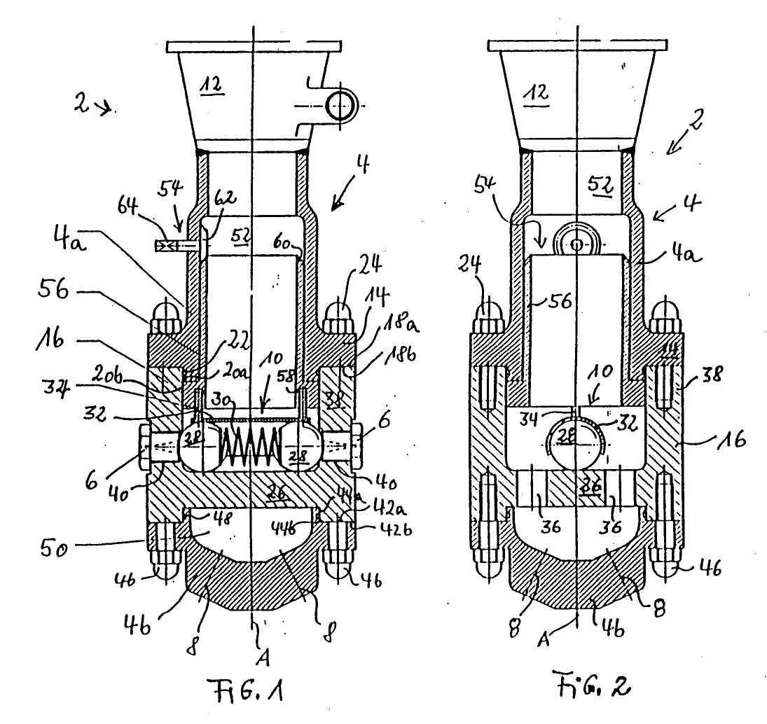

FIG. 1 shows a tool 2 with a housing 4, two nozzles for cutting coke 6 and two more nozzles (schematically shown) for drilling coke 8 and a valve 10 for opening and closing nozzles 6, 8.

In operation, tool 2 is attached to a drill stem (not shown) and is inserted in a drum filled with coke. Indications such as “top” and “bottom” refer to axis A of the tool shown in FIGS. 1 to 4 aligned with the drill stem (top) and a hole to be made by the tool (bottom; not shown).

Housing 4 is made of two parts. Valve 10 is arranged between the top housing half 4a arranged at the drill stem (not shown) and the bottom housing half 4b. Top housing half 4a is attached to the drill stem via a flange 12 from where it extends as an essentially hollow body to bottom housing half 4b. At the end of top housing part 4a associated with valve 10, a circular support 14 is integrally formed. At this support 14 a valve carrier 16 is disposed on the bottom.

For simple and precise alignment of valve carrier 16 at support 14, corresponding contacting surfaces 18a and 18b, and 20a and 20b are provided at support 14 and valve carrier 16. In the area of contacting surfaces 20a, 20b, a circular sealing ring 22 is provided.

Valve carrier 16 is bolted to support 14 using bolts engaging threaded bores (not shown) in support 14 and in valve carrier 16.

Valve carrier 16 is a cylindrical hollow body in which an intermediate web 26 is formed extending essentially at right angles to axis A. Two balls 28 of ball valve 10 are arranged to run on the web 26. Balls 28 are positioned at the outer periphery of web 26 or valve carrier 16. In this position they are held both during the “drilling” and “cutting” operating states, and during a switch-over from one operating state to the other, by positioning aids. In the present embodiment, the positioning aid is formed as a spring 30 exerting a force between the two balls 28.

The position of balls 28 on the web 26 is determined by the means for guiding the balls. These means for guiding the balls 28 are concave shells 32 in the present embodiment, embracing the top half of the balls 28 as well as spring 30. A guide 34 extents from concave shells 32 upwards.

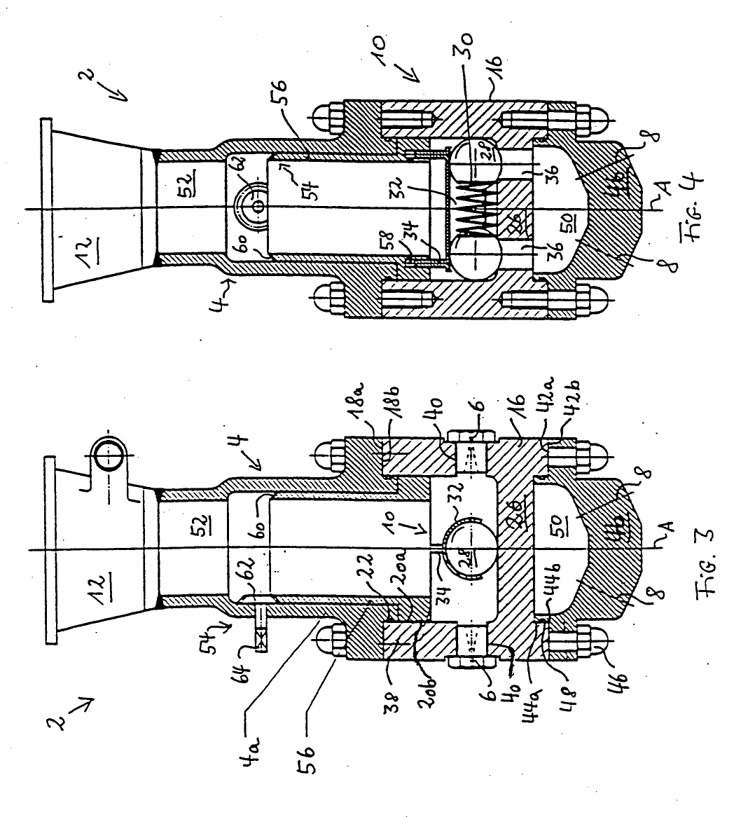

Web 26 of valve carrier 16 comprises bores 36, as shown in FIG. 2, whose number is equal to the number of balls 8. Valve carrier 16 has bores 40, into which cutting nozzles 6 are inserted, at its outer wall 38.

Below the web 26 or at its bottom surface, contacting surfaces 42a and 42b, and 44a and 44b are provided. Contacting surfaces 42a,b are parallel to axis A while contacting surfaces 44a,b are vertical to axis A.

The bottom housing half 4b contacts these contacting surfaces 42a,b and 44a,b and is attached to the valve carrier by bolts 46 which engage threaded bores (not shown) of valve carrier 16. In the area of contacting surfaces 44a,b, a circular sealing ring 48 is provided.

A cavity 50 in the bottom housing half 4b ensures that liquid can pass unhindered through bores 36 to drilling nozzles 8 positioned in the bottom housing half 4b. Drilling nozzles 8 are only schematically shown.

The tool 2 shown in FIGS. 1 and 2 is in the “drilling” operating state (drilling state). In the drilling state, balls 28 of ball valve 10 block bores 40 in the outer wall 38 of valve carrier 16. The diameter of balls 28 is such that bores 40 are reliably and completely covered.

At the same time, as shown in FIG. 2, bores 36 in web 26 of valve carrier 16 are left free. Water entering tool 2 at high pressure from the drill stem, flows through the interior 52 within the tool above web 26, through bores 36, passes through cavity 50 in the bottom housing half 4b, and then exits through nozzles 8 into a drum filled with coke (not shown).

To switch over from the drilling state into the “cutting” operating state, an apparatus 54 for operating valve 10 is provided at tool 2. Apparatus 54 comprises a cylindrical hollow body 56 inserted in the top housing half 4a. The bottom end of this hollow body 56 has recesses 58 in engagement with guides 34 of ball valve 10. The top end 60 of hollow body 56 is formed in the manner of a gear rim. A gear 62 is in mesh with said top end 60 of hollow body 56 formed in the manner of a gear rim. An axle 64 is attached to gear 62 extending through top housing half 4a. Axle 64 is manually adjusted using a wrench.

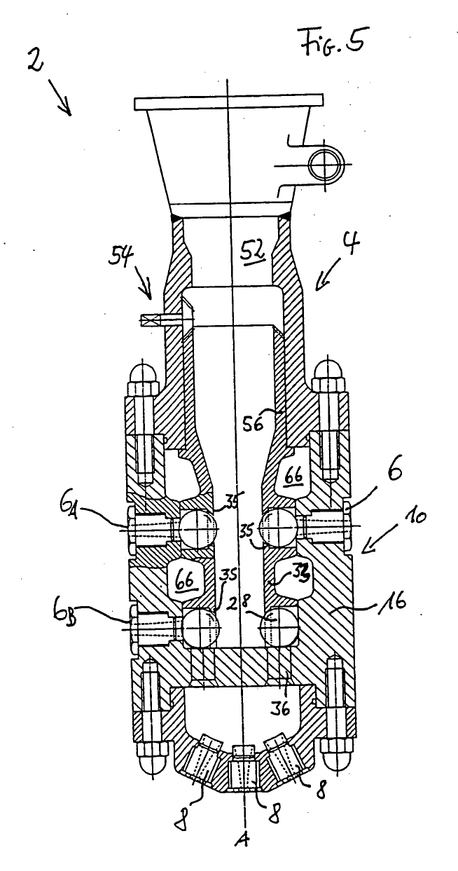

To switch over from the drilling state to the “cutting” operating state, gear 62 is operated by turning axle 64. Hollow body 56 in mesh with gear 62 is rotated within the top housing half 4a by gear 62. Guide 34 and with it balls 28 of ball valve 10 are rotated together with hollow body 56. By rotating balls 28 on valve carrier 16, bores 40 that had closed off nozzles 6, are now exposed (cf. FIG. 3). By operating handle 64, balls 28 move on a circular path until bores 36 are completely closed off (cf. FIG. 4).

FIGS. 3 and 4 show a tool 2 in the cutting operating state. Water at high pressure flows from the drill stem into interior 2 of the top housing half 4a and exits from the cutting nozzles, the only possible outlets, at about right angles to axis A. Bores 36 are safely and completely blocked by balls 28 positioned on top of them. The closing action of balls 28 is additionally secured in this position and, likewise, when bores 40 are blocked by the fact that the extremely high pressure of the water, far above 100 bars, presses the balls to the valve carrier.

The exemplary embodiment shown in FIGS. 1 to 4 concerns an embodiment of the invention with two nozzles 6 for cutting and two nozzles 8 for drilling. However, embodiments are also covered by the subject matter of the invention with three or more nozzles 6 or nozzles 8, respectively. Neither is it necessary for the numbers of nozzles 6 and of nozzles 8 to be equal. In particular with embodiments of the invention having three or more nozzles requiring more than two balls 28, a separate guide for each ball may serve as a positioning aid. Spring 30 is then no longer needed.

Such an embodiment of tool 2 having a plurality of nozzles is shown in FIG. 5 (equivalent features are designated with identical reference numerals). Tool 2 has a housing 4 and a valve 10. Valve carrier 16 is inserted in the housing. Cutting nozzles 6 as shown in FIG. 5 are arranged in two levels, one on top of the other. Nozzles 6A and 6B are shown to be vertically aligned, whereas in fact they are offset at an angle of about 60° to each other. This is indicated by cross-hatching.

Balls 28 opening or closing, depending on the operating state, nozzles 6 and openings 36 supplying drilling nozzles 8, are received in means for guiding, which fix balls 28 in predetermined positions and act as a support 33 together with guiding protrusions 35 integral with it. Support 33 is attached to cylindrical hollow body 56 as part of apparatus 54 for operating valve 10. Guiding protrusions 35 effect a secure positioning of balls 28 so that no springs are needed. Apparatus 54 for operating the valve otherwise corresponds to the embodiments shown in FIGS. 1 to 4.

Between housing 4, valve carrier 16 and the means 33 for guiding the balls 28, there are gaps 66 in flow communication with interior cavity 52. In operation, the water flowing through tool 2 therefore flows both through interior cavity 52 and through gaps 66 so that any pressure differentials are avoided.

1. A tool for disintegrating coke, having
a housing attached to a drill stem in operation, and at which or in which
at least one nozzle for cutting and a nozzle for drilling of coke and at least one valve for closing and opening the nozzles is arranged, wherein said tool is adapted to have two different operating states and wherein said at least one valve closes off said cutting nozzles in the drilling operating state, while the drilling nozzles are closed off by said valve in the cutting operating state,
and wherein said housing, said valve and said nozzles are adapted so that water may flow unhindered from said drill stem through said housing and said valve and through the nozzles not closed off by said valve,
characterized in that
the nozzles to be closed, depending on each chosen operating state, are closed off by the balls of a ball valve.

2. The tool of claim 1, characterized in that said balls (28) are spherically formed at least in sections.

3. The tool of claim 2, characterized in that said balls (28) have at least two spherical surface sections.

4. The tool according to claim 1, characterized in that said balls (28) are symmetrical.

5. The tool of claim 1, characterized in that said balls (28) are held in position by a spring (30).

6. The tool of claim 1, characterized in that said balls (28) of said ball valve (10) engage means (32) for guiding.

7. The tool of claim 6, characterized in that said means for guiding said balls (28) of said ball valve (10) are concave shells (32) embracing said balls (28).

8. The tool of claim 1, characterized in that said valve (10) engages means (54) for operating said valve, in particular for switching over from a first operating state to a second operating state.

9. The tool of claim 8, characterized in that said means (32) for guiding said balls (28) have a guide (34) engaging means (54) for operating said valve (10).

10. The tool of claim 1, characterized in that said valve carrier (16) is arranged in said housing (4), and between said housing (4) and said valve carrier (16) there is a gap (66), wherein said gap (66) is in flow communication with said interior cavity (52) of said tool.

11. The tool of claim 1, characterized in that at least two nozzles (6) for cutting are inserted in bores (40) and at least two bores (36) are arranged in the web (26) of a valve carrier (16) of said valve (10), and in that these bores (36) are blocked by said balls (28) when said tool (2) is in said cutting operating state, and said bores (40) are blocked by said balls (28) when said tool (29) is in a drilling operating state.

12. The tool of claim 11, characterized in that said at least two nozzles (6A, 6B) are arranged one on top of the other.

13. The tool of claim 1, characterized in that said tool comprises means (54) for operating said valve (10), wherein said means (54) are arranged between said nozzles (6, 8) and the top end of said tool (2).
